(19) United States
(12) Patent Application Publication
(10) Pub. No.: US 2003/0052903 A1
(43) Pub. Date: Mar. 20, 2003

(54) Method and apparatus for focus based lighting

(76) Inventor: John C. Weast, Hillsboro, OR (US)

Correspondence Address: Judith A.Szepesi, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/957,951

(22) Filed: Sep. 20, 2001

(51) Int. Cl. G09G 5/10

(52) U.S. Cl. 345/690

(57) ABSTRACT

A method and apparatus for lighting a display screen that comprises fully illuminating a relevant portion of the display screen, and using reduced illumination on a remaining portion of the display screen. As a result, power consumption is decreased compared to full lighting of the entire display screen.

### FIELD OF THE INVENTION

The present invention relates to display technology, and more specifically, to focus based lighting of a display.

### BACKGROUND

One of the greatest problems facing mobile computing is the high rate of power consumption in today's mobile computers. Generally, the portions of the computer consume the highest levels of power are the processor or CPU, the hard drive, and the display screen. In the prior art, the power savings were achieved by powering down one or more of these devices if the system was idle for a time. Additionally, the prior art provides a method of reducing power consumption during extremely short idle times as well. Processors have varying levels of power savings that are incrementally increased as the idle time increases.

In the prior art, there was an attempt to reduce the power level consumed by the processor and the hard drive while the computer system was active. Thus, while the hard drive is inactive for a period of time, it can be spun down. Similarly, the processor may not always be used. Thus, the processor may be put into a lower power consumption state. Thus, the power consumed by both the hard drive and the processor has been reduced.

Turning screen off completely when there is been an extended idle period is known in the art. However, there has been no increased power awareness with respect to the display screen, for shorter idle times. This problem has not been recognized by those in the art.

### BRIEF DESCRIPTION OF THE DRAWINGS

FIG. 1 is a block diagram of one embodiment of a computer system on which the present invention may be implemented.

FIG. 2 is a block diagram of one embodiment of a selective lighting system.

FIGS. 3 and 4 are flowcharts of one embodiment of using a selective lighting system.

FIGS. 5A and B are examples of the selective lighting system in use in accordance with the present invention.

### DETAILED DESCRIPTION

At any moment, most computer system users are only focusing on a small portion of the total screen area. The majority of work is done in applications such as text editors, email systems, web browsers, etc. In each of these cases, the user is actually only interacting with a small portion of the screen area. For example, in a word processing program, only the area that is actually being read/written and the few lines above and below that are relevant to the user.

By selectively lighting portions of a computer screen, energy can be saved. This is particularly useful in applications such as mobile computers, in which rate of power consumption is a concern. A display screen can use as much as 20% of the power in a computer. Thus, if selective lighting reduces the power consumption even by 50%, i.e. lighting 50% of the computer screen, the battery lifetime of the computer system may be increased by 10% or more. This can be significant.

Current research and upcoming display technologies are providing display areas that are capable of independently powering separate portions of the display. Generally, for LCD (liquid crystal display) panels, an inverter is used to provide backlighting using one or more tubes. Ninety percent of the power in a flat-panel LCD display is used for backlighting not for generating the picture. The backlighting may be provided by multiple tubes. Each tube can be turned on and off separately. Thus, an inverter that uses multiple tubes permits the powering down of portions of the LCD screen, while powering other portions. This results in significant power savings.

Additionally, new display technologies such as organic based displays provide the lighting/power to each pixel separately. Thus, the portions of the screen that are lit and unlit may be defined arbitrarily based on user preferences. One additional technology is cholesteric displays. Cholesteric LCDs are bright under reflection and are bistable: Once an image is written to the display, the image is remains on the display even after power is removed.

In all of these cases, power can be selectively removed from some portion of the display, leaving the area that is powered down in its low-power state. In general, it is expected that powered down in this way, the computer screen uses considerably less power than a fully powered computer screen. Therefore, it would be advantageous to selectively power only a portion of the computer screen that is actually relevant to the user.

The present system determines the user's focus area based on cursor movement, mouse movement, eye movement, actual indication by the user or other means. Then, based on the focus area, the system interpolates a relevant area of the display to illuminate to provide sufficient amount of illumination to be useful. For example, in a text editor the user may wish to see the entire paragraph, or at least five or ten lines above and below the currently edited portion of the text.

For one embodiment, the present system includes a lighting controller that interface with whatever display mechanism is present, to set the illumination level in accordance with the preferences. Furthermore, a user interface permits the user to control these preferences, in one embodiment. For one embodiment, the user may furthermore set the level of battery conservation versus illumination area and intensity. If battery conservation is important, the user may set the system to illuminate only the most relevant portion of the screen, turning off the remaining portions of the screen. If illumination is preferred, the entire screen may remain lit. Alternatively, there may be a gradation of lighting from the relevant portion outward, such that there is no strong delineation between the relevant portions and other areas of the screen.

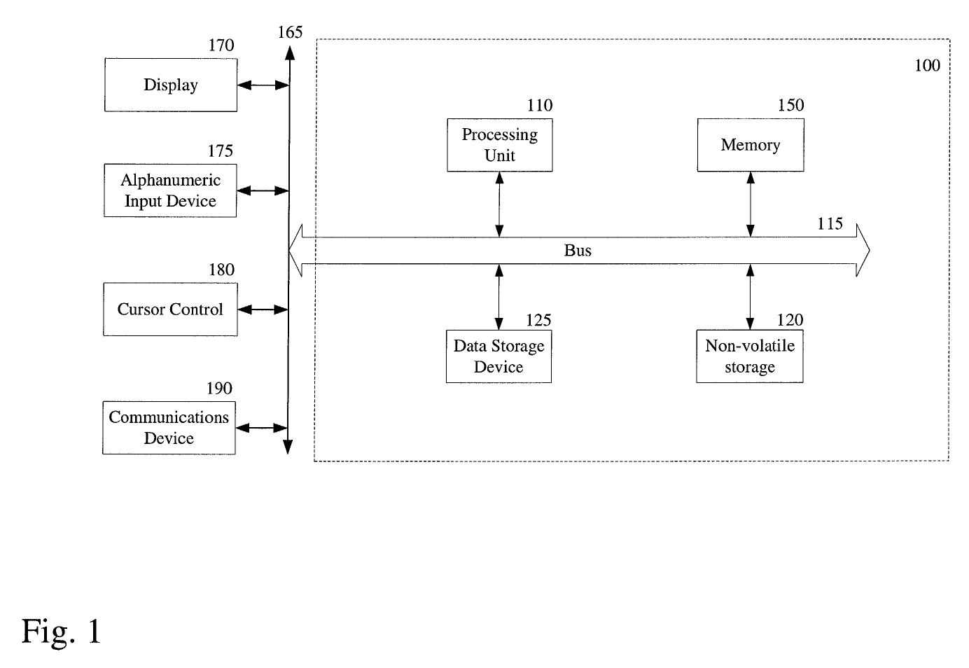

FIG. 1 is one embodiment of a computer system that may be used with the present invention. It will be apparent to those of ordinary skill in the art, however other alternative systems of various system architectures may also be used.

The data processing system illustrated in FIG. 1 includes a bus or other internal communication means 115 for communicating information, and a processor 110 coupled to the bus 115 for processing information. The system further comprises a random access memory (RAM) or other volatile storage device 150 (referred to as memory), coupled to bus 115 for storing information and instructions to be executed by processor 110. Main memory 150 also may be used for storing temporary variables or other intermediate information during execution of instructions by processor 110. The system also comprises a read only memory (ROM) and/or static storage device 120 coupled to bus 115 for storing static information and instructions for processor 110, and a data storage device 125 such as a magnetic disk or optical disk and its corresponding disk drive. Data storage device 125 is coupled to bus 115 for storing information and instructions.

The system may further be coupled to a display device 170, such as a cathode ray tube (CRT) or a liquid crystal display (LCD) coupled to bus 115 through bus 165 for displaying information to a computer user. An alphanumeric input device 175, including alphanumeric and other keys, may also be coupled to bus 115 through bus 165 for communicating information and command selections to processor 110. An additional user input device is cursor control device 180, such as a mouse, a trackball, stylus, or cursor direction keys coupled to bus 115 through bus 165 for communicating direction information and command selections to processor 110, and for controlling cursor movement on display device 170.

Another device, which may optionally be coupled to computer system 100, is a communication device 190 for accessing other nodes of a distributed system via a network. The communication device 190 may include any of a number of commercially available networking peripheral devices such as those used for coupling to an Ethernet, token ring, Internet, or wide area network. The communication device 190 may further be a null-modem connection, or any other mechanism that provides connectivity between the computer system 100 and the outside world. Note that any or all of the components of this system illustrated in FIG. 1 and associated hardware may be used in various embodiments of the present invention.

It will be appreciated by those of ordinary skill in the art that any configuration of the system may be used for various purposes according to the particular implementation. The control logic or software implementing the present invention can be stored in main memory 150, mass storage device 125, or other storage medium locally or remotely accessible to processor 110.

It will be apparent to those of ordinary skill in the art that the system, method, and process described herein can be implemented as software stored in main memory 150 or read only memory 120 and executed by processor 110. This control logic or software may also be resident on an article of manufacture comprising a computer readable medium having computer readable program code embodied therein and being readable by the mass storage device 125 and for causing the processor 110 to operate in accordance with the methods and teachings herein.

The present invention may also be embodied in a handheld or portable device containing a subset of the computer hardware components described above. For example, the handheld device may be configured to contain only the bus 115, the processor 110, and memory 150 and/or 125. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 110, a data storage device 125, a bus 115, and memory 150, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing the present invention can be stored on any machine-readable medium locally or remotely accessible to processor 110. A machine-readable medium includes any mechanism for storing or transmitting information in a form readable by a machine (e.g. a computer). For example, a machine readable medium includes read-only memory (ROM), random access memory (RAM), magnetic disk storage media, optical storage media, flash memory devices, electrical, optical, acoustical or other forms of propagated signals (e.g. carrier waves, infrared signals, digital signals, etc.).

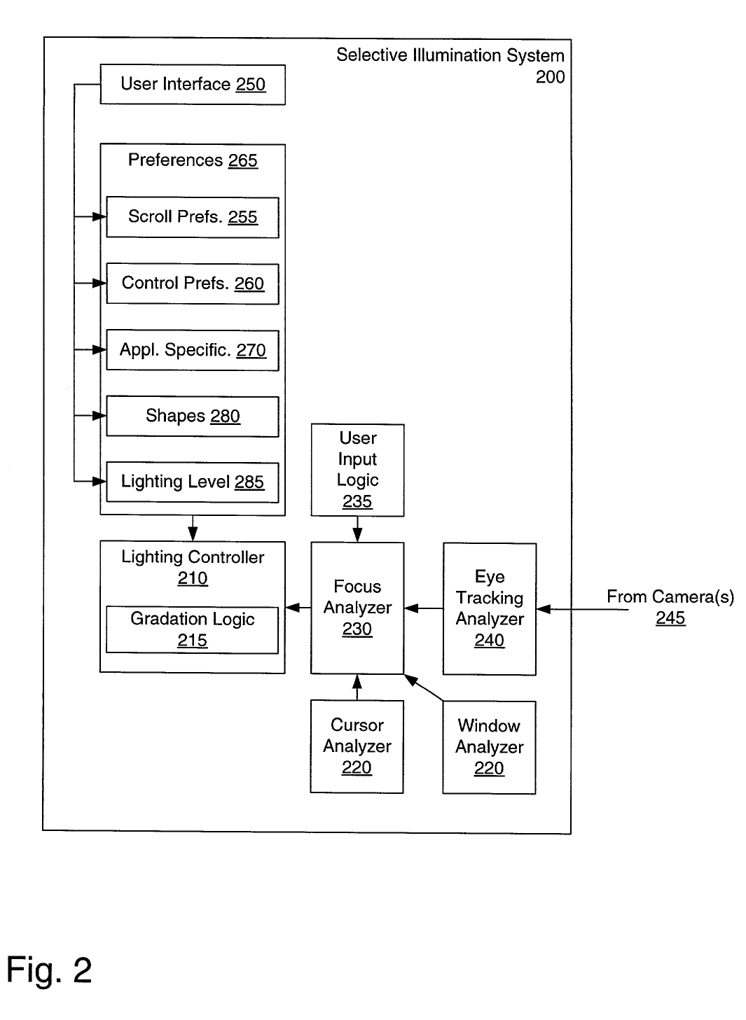

FIG. 2 is a block diagram of one embodiment of a selective lighting system. The system includes a lighting controller 210 for controlling the level of illumination of various portions of the display area. The lighting controller 210 interfaces with the hardware of the system, to control the level of illumination. For one embodiment, the lighting controller 210 intercepts data sent to or from a video card, and overwrites the brightness/illumination levels of the areas that are being toned down. For one embodiment, the system includes a specific pixel value or pixel encoding that indicates to the lighting controller that the pixel should not be powered. For one embodiment, the lighting controller 210 alters the data received by the video card, to indicate this power state. For example, the pixel data associated with areas that should not be powered is written to −1, to indicate that power should be removed from the pixel.

For another embodiment, the lighting controller 210 may be part of the video card, and the video card may be designed to not calculate the display for the portions of the screen that are not illuminated. Alternatively, the lighting controller 210 may be a hardware device specifically designed to control the display. Alternative methods of implementing a lighting controller 210 in hardware, software, or a combination of the two, may be utilized.

Lighting controller 210 includes gradation logic 215. Gradation logic 215 calculates the relative lighting levels needed for all areas outside of the “relevant portion” which is fully lit. The gradation logic 215 may not be needed if areas outside the relevant portion of the screen are simply not illuminated at all. Otherwise, the illumination levels of those areas are calculated by gradation logic.

Lighting controller 210 receives input from focus analyzer 230. Focus analyzer 230 determines where the user's current focus is. The focus analyzer 230 may receive various types of input. The focus analyzer 230 may receive input from a cursor analyzer 220, indicating where a cursor is located; a window analyzer 225 indicating which window is “active” or “on top”; an eye track analyzer 240 indicating where the user's eyes are; and/or user input logic 235 to receive actual direct user input.

The cursor analyzer 220 reports the location of the cursor. The cursor may be the within-application cursor, such as a text input cursor in an editor. The cursor may also be the mouse cursor. In general, the text input cursor, when it is active, takes precedence over the mouse cursor. In many applications, the text input (or equivalent drawing control, etc.) cursor removes the mouse cursor from the screen. In any case, cursor analyzer 220 determines a location of the cursor, and passes this data to focus analyzer 230. When a text input cursor, or a mouse cursor, is active on the screen, this generally indicates that the user is entering data, or reading data. Therefore, the focus of the user may be predicted at the location of that cursor. The focus analyzer 230 takes the location data from cursor analyzer 220, and based on the predicted focus of the user, an actual relevant area, the focus area of the user, is calculated.

The window analyzer 225 simply identifies the currently active window. In many operating systems, only a single window can be active at one time. In other systems, multiple windows may be considered active. In either case, the identity of the window(s) that are active are identified and passed to the focus analyzer 230.

The eye track analyzer 240 receives data from camera(s) 245, to indicate where the user's eyes are pointing. The user's eyes generally track the current focus of the user's interest. For example, if a user is typing into an editor, the eyes generally track the currently entered data. If a user is reading, the eyes can be tracked to determine the current location on the page where the user is reading. The use of such eye tracking software is known in the art, for cursor control as well as for other uses. The user's focus area is passed to the focus analyzer 230 that calculates the actual location of the user's attention.

The user input logic 235 receives data from the user indicating his or her current point of focus. This may be done via a touch screen or similar mechanism, via various keyboard controls, or by other means. For one embodiment, the user may employ a signaling key (such as shift) and directional keys (such as the directional arrows) to indicate a preferred point of focus, with respect to the currently illuminated region of the screen.

Note that focus analyzer 230 may further receive data from other sources. Alternatively, a subset of these sources may be present. The focus analyzer 230 passes the data specifying the region of the user's focus to the lighting controller 210.

The lighting controller 210 to determine the size, shape, and other aspects of the illumination pattern to be displayed also receives data from preferences 265 in memory set by a user. For example, a user may set application specific preferences 270, and shapes 280. For one embodiment, the shapes are limited to the shapes that may be easily produced by the system. Logical shapes include rectangles of various sizes, ovals, etc. For one embodiment, however, the user may further specify alternative shapes. The shapes may be whimsical, including for example flowers, clouds, etc.

The application specific preferences 270 may specify certain lighting for certain applications. For example, a user may prefer, in a text editor, to light an entire paragraph above the cursor, and only one line below the cursor. The user may further prefer a certain level of lighting for menu items, such that the user can easily see the menu. For one embodiment, the user may also set preferences such as disabling the mouse cursor for adjusting user focus. For example, there may be a user who plays with the mouse while editing documents. That user may set the preference that the mouse cursor is not followed to indicate user focus, unless a mouse button is depressed.

The user may further set the preference for the level of lighting 285. The level of lighting 285 indicates the gradation between the set relevant portion of the display screen, and the areas outside that portion. For example, the lighting level 285 may indicate that the user prefers a gradual lessening of the brightness/lighting outward, to complete darkness.

The user may further set a current energy consciousness level 290, which indicates where along the scale from only lighting a minimum portion of the screen to completely illuminating the entire screen the user's preferences lie. For example, if the computer system is plugged in, the user may prefer to have the entire screen illuminated, while on travel, the user may prefer only the minimal area lit, to extend battery power. Similarly, when the user is in a location where others may be observing him or her, to maximize privacy, the minimum area of the screen needed for context for the user may be illuminated.

The system includes a user interface 250 to permit the user to set the preferences 265 discussed above. The user interface 250 may further include a scroll setup 255. The scroll setup 255 identifies a reading rate of the user, to permit the lighting to automatically move downward as the user reads. For one embodiment, the lighting controller 210 may detect reading, based on the continuous movement downward of the user's focus, or similar standards, and use the preset scroll preference data 255 to automatically move the lighting downward at the appropriate speed.

The user interface 250 may further permit the user to set up a set of control key preferences 260, to identify which keys the user would like to set to control the lighting. In this way, the user may customize and use a lighting control system that permits a portion of the computer screen to be lit, while the remainder of the computer screen remains dark. The advantages of this system are power savings as well as increased privacy.

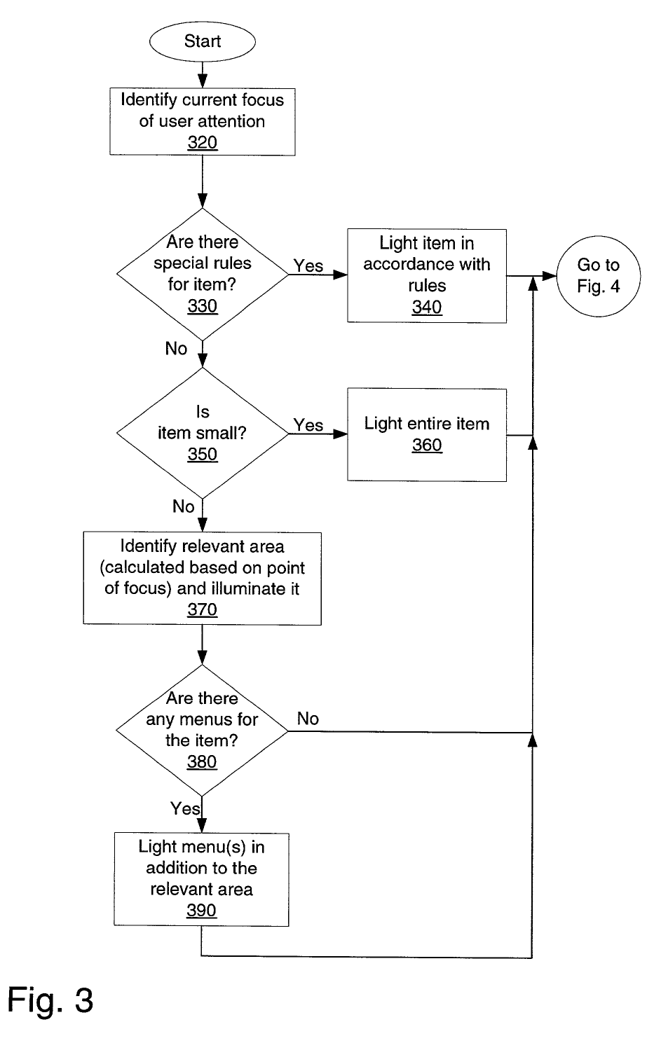

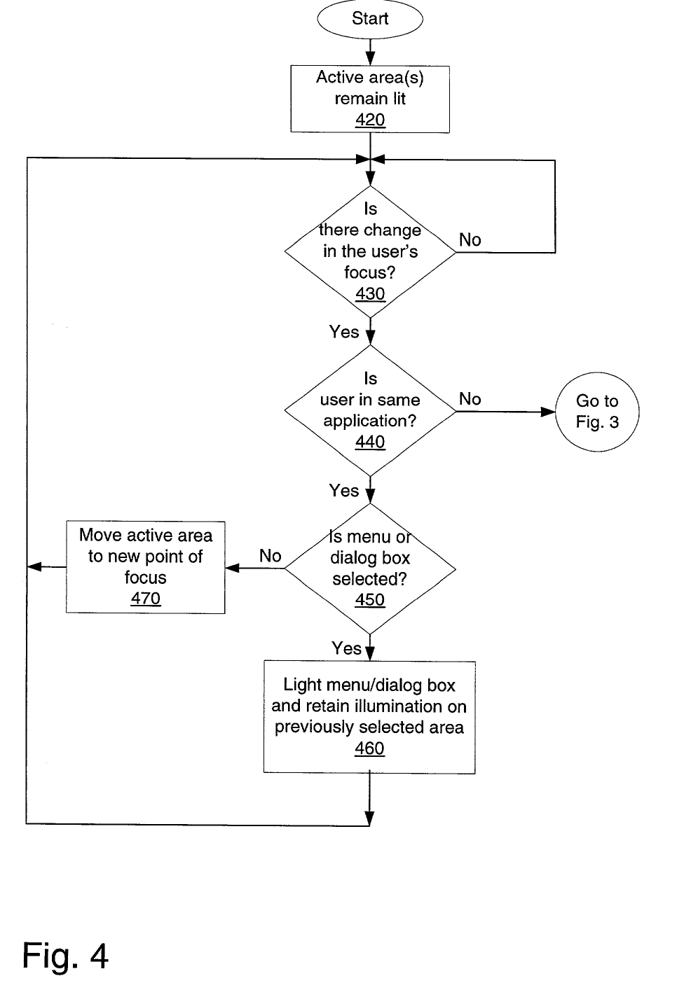

FIGS. 3 and 4 are flowcharts of one embodiment of using a selective lighting system. The process starts at block 310. For one embodiment, the process starts when the user enables the selective lighting option. For one embodiment, the user may set up to enable the selective lighting option whenever a computer system is not coupled to external power, i.e. whenever it is running off batteries. Alternatively, the user may affirmatively select the option. For yet another embodiment, if the computer system was previously set to run selective lighting, the preference is used the next time the computer is turned on. The user may set alternative preferences.

At block 320, the current focus of the user's attention is identified. As discussed above, this may be done by locating a cursor, identifying a currently active window, tracking the user's eyes, or receiving user input indicating the preferred focus area.

At block 330, the process determines whether the user set up application specific preferences for the application on which the user's attention is currently focused. If special preferences are set up, the process continues to block 340. At block 340, the application/item is lit in accordance with the specific preferences set by the user. For one embodiment, the user may adjust these preferences using control keys. For one embodiment, the user may save the altered preferences with a key combination, or in another way. The process then continues to FIG. 4, to describe switching between attention points.

If no specific preferences were found the process continues to block 350. At block 350, it is determined whether the current window/menu/application area is small. If so, the process continues to block 360. For one embodiment, for small windows, the preference is set to light the entire window area. Thus, at block 360, the entire small window area is lit or identified as the relevant portion of the screen, leaving the non-relevant portions of the screen dark or unpowered. The process then continues to FIG. 4.

If the window is not small, the process continues to block 370. At block 370, the relevant portion of the window is lit. As discussed above, the cursor, eye location, or user input may be used to identify this portion.

At block 380, the process determines whether there are any menus that are associated with the current application. If there are no menus, then the needed area of the application is already lit, and the process continues to FIG. 4. For another embodiment, the menu may remain unlit until the user's focus moves to it. If there are menus, the process continues to block 390. At block 390, the menus are lit. For one embodiment, the menus are lit at a lower power level, but sufficiently brightly to permit a user to visually identify the menu item. For another embodiment, these two processes may be skipped, and the menu may remain unlit. Since the mouse cursor is followed, or if an ALT-key is used to open a menu, the menu is lit, there may be no need to always light the menu. For one embodiment, the user may set the default preferences. The process then continues to FIG. 4.

FIG. 4 is a flowchart of one embodiment of the reaction to a change in the user's focus. At block 420, the active area(s) are lit. This block encompasses the processes described above with respect to FIG. 3.

At block 430, the system monitors whether there is a change in the user's focus. This is continuously monitored, until a change in focus is detected. At that point, the process continues to block 440.

At block 440, the process determines whether the user has remained in the same application previously selected. If not, the process continues to FIG. 3. As discussed above, FIG. 3 permits the system to identify application-specific lighting.

If the user has remained in the same application, the process continues to block 450. At block 450, the process determines whether the user's focus has changed by opening a menu and/or dialog box. If not, the process continues to block 470. At block 470, the active area indicating the users focus is moved within the application, as appropriate. The process then returns to block 430, to continue monitoring for changes in focus.

If a menu and/or dialog box has been detected, the process continues to block 460. At block 460, the menu/dialog box is illuminated, while retaining lighting on the previously active area within the application. For one embodiment, this is a preference that is configurable by the user. Generally, when the user selects a menu item, he or she is going to be applying certain characteristics or making certain changes to the underlying displayed area. For one embodiment, this is configurable by application, since whether the menu items affect the underlying displayed area is application dependent. Thus, both areas should be lit at the same time, for certain applications. For one embodiment, the previously active area may be lit less brightly than the currently active menu. the process then returns to block 430, to continue monitoring for changes in focus.

In this way, the process permits the user to change his or her focus continuously, while maintaining a selectively lit area around the current point of the user's attention. This permits substantive power savings while also increasing the security level.

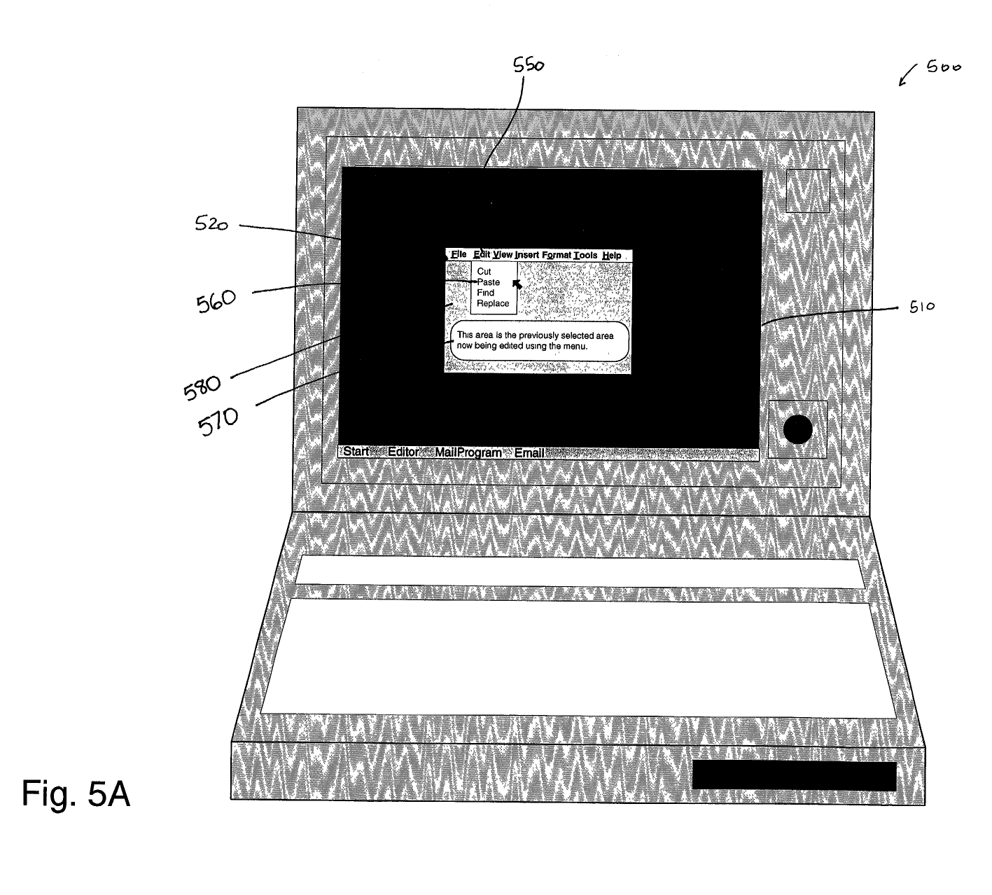

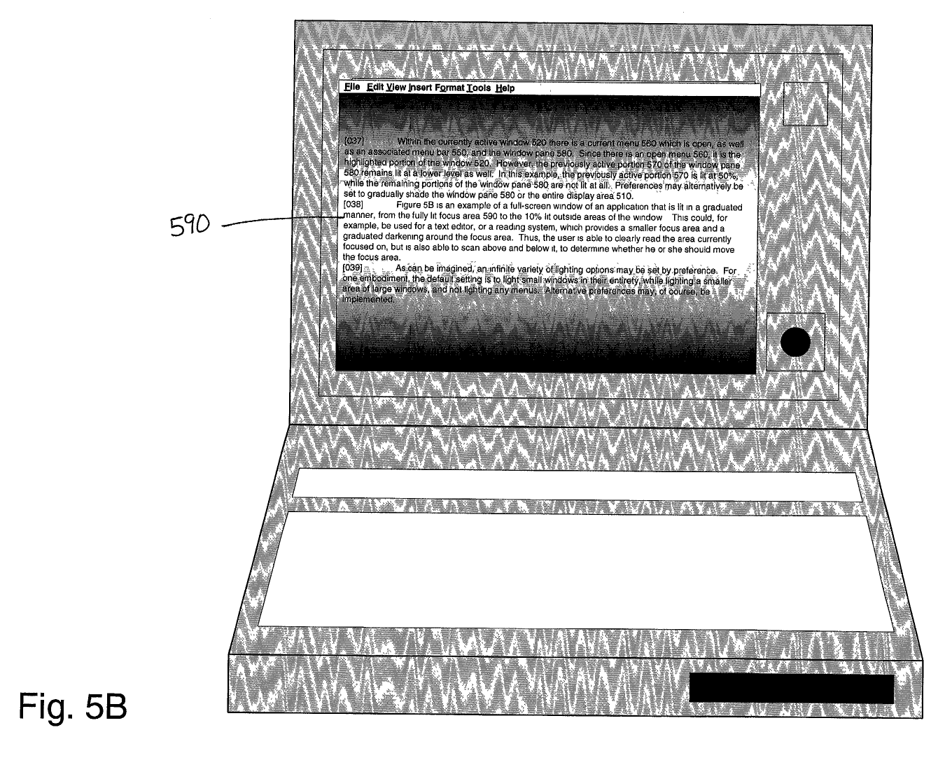

FIG. 5A is an example of the selective lighting system in use in accordance with the present invention. As can be seen, the system 500 includes a large screen area 510. The screen area includes a currently active window 520, as well as an operating system menu bar 540. In this example, the user has set a preference that the operating system menu bar 540 remain lit at a low level.

Within the currently active window 520 there is a current menu 560 which is open, as well as an associated menu bar 550, and the window pane 580. Since there is an open menu 560, it is the highlighted portion of the window 520. However, the previously active portion 570 of the window pane 580 remains lit at a lower level as well. In this example, the previously active portion 570 is lit at 50%, while the remaining portions of the window pane 580 are not lit at all. Preferences may alternatively be set to gradually shade the window pane 580 or the entire display area 510.

FIG. 5B is an example of a full-screen window of an application that is lit in a graduated manner, from the fully lit focus area 590 to the 10% lit outside areas of the window. This could, for example, be used for a text editor, or a reading system, which provides a smaller focus area and a graduated darkening around the focus area. Thus, the user is able to clearly read the area currently focused on, but is also able to scan above and below it, to determine whether he or she should move the focus area.

For one embodiment, the fully lit focus area 590 automatically scrolls, in accordance with the user's preference. This permits the user to set up a rate-ofreading speed once, and automatically have the focus area scroll at that speed. For another embodiment, the fully lit focus area 590 moves in response to the user's eye movements, in response to control keys, or as controlled by another mechanism.

As can be imagined, an infinite variety of lighting options may be set by preference. For one embodiment, the default setting is to light small windows in their entirety, while lighting a smaller area of large windows, and not lighting any menus. Alternative preferences may, of course, be implemented.

The system and process described above uses selective lighting to decrease power use and increase privacy for computer systems. As described above, the illumination is focused around the current point of attention of the user. In this way, an improved method of lighting for a display area is achieved.

In the foregoing specification, the invention has been described with reference to specific exemplary embodiments thereof. However, it will be evident to one skilled in the art that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method of lighting a display screen comprising:
fully illuminating a relevant portion of the display screen; and
using reduced illumination on a remaining portion of the display screen, such that power consumption is decreased compared to full lighting of the entire display screen.

2. The method of claim 1, wherein reduced illumination comprises turning off the illumination on the remaining portion of the display screen.

3. The method of claim 1, wherein reduced illumination comprises graduated illumination from fully illuminated to minimal illumination.

4. The method of claim 1, further comprising:
identifying the relevant portion of the display screen based on an attention of the user.

5. The method of claim 4, wherein the attention of the user is determined based on tracking an eye motion of the user.

6. The method of claim 4, wherein the attention of the user is determined based on tracking a cursor.

7. The method of claim 4, wherein the attention of the user is determined based on preferences.

8. The method of claim 7, wherein the preferences are application specific preferences.

9. The method of claim 8, further comprising:
determining a default configuration of the illumination; and
identifying if a special case applies to a current application to modify the default configuration.

10. The method of claim 1, further comprising, in an application:
detecting a selection of a menu;
illuminating the menu as the menu is displayed; and
continuing to illuminate the relevant portion of the display screen illuminated prior to the selection of the menu.

11. The method of claim 1, further comprising:
in a non-full-screen window, defining the entire non-full-screen window as the relevant portion of the display screen.

12. The method of claim 1, further comprising:
detecting a dialog box;
identifying whether the dialog box is associated with the relevant portion illuminated prior to the appearance of the dialog box; and
continuing to illuminate the relevant portion of the display screen illuminated prior to the appearance of the dialog box if the dialog box is associated with the application.

13. The method of claim 1, further comprising:
permitting a user to select between a power-saving mode having reduced illumination and a full illumination mode that illuminates the entire display screen.

14. A method comprising:
determining a relevant portion of a display area of a mobile computing system; and
fully lighting the relevant portion of the display area, while reducing power used in lighting areas outside the relevant portion of the display area.

15. The method of claim 14, further comprising:
tracking a focus of a user; and
moving the relevant portion of the display area as the focus of the user moves.

16. The method of claim 14, further comprising:
permitting a user to customize the relevant portion of the display area, including a shape, size, and location.

17. An apparatus comprising:
a focus analyzer to determine a relevant portion of a display screen based on a current focus of a user; and
a lighting controller to fully illuminate the relevant portion of the display screen, and to provide reduced illumination to a remaining portion of the display screen, such that power consumption is decreased compared to full lighting of the entire display screen.

18. The apparatus of claim 17, wherein reduced illumination comprises turning off the illumination on the remaining portion of the display screen.

19. The apparatus of claim 17, wherein reduced illumination comprises graduated illumination from fully illuminated to minimal illumination.

20. The method of claim 17, further comprising:
an eye track analyzer to detect the current focus of the user based on tracking eye motions of the user.

21. The apparatus of claim 17, further comprising:
a cursor analyzer to detect the current focus of the user based on identifying a cursor location.

22. The apparatus of claim 17, further comprising:
a window analyzer to detect the current focus of the user based on identifying a currently active window.

23. The apparatus of claim 17, further comprising:
a scroll preference to automatically scroll the relevant portion of the display screen downward as a user reads.

24. The apparatus of claim 17, further comprising:
a lighting level preference to permit a user to select between a power-saving mode having reduced illumination and a full illumination mode that illuminates the entire display screen.

25. The apparatus of claim 24, wherein the lighting level preference may be set at various levels from complete illumination to minimum illumination.

26. An apparatus comprising a machine readable medium containing instructions which, when executed by a machine, cause the machine to perform operations comprising:
fully illuminating a relevant portion of the display screen; and
using reduced illumination on a remaining portion of the display screen, such that power consumption is decreased compared to full lighting of the entire display screen.

27. The apparatus of claim 26, further comprising the machine readable medium containing instructions which, when executed by the machine, cause the machine to perform operations comprising:
identifying the relevant portion of the display screen based on an attention of the user.

28. The apparatus of claim 27, wherein the attention of the user is determined based on tracking an eye motion of the user.

29. A system comprising:
a display screen;
a lighting controller to control a level of illumination on the display screen;
a focus analyzer to determine a relevant portion of the display screen based on a current focus of a user;
a cursor analyzer to receive cursor location, the focus analyzer to use the cursor location to determine the current focus of the user; and
the lighting controller to fully illuminate only a portion of the display screen centered around the current focus of the user.

30. The system of claim 29, further comprising:
a camera to capture images of the user; and
an eye track analyzer to determine a location currently being viewed by the user, the focus analyzer to use the location currently being viewed by the user to determine the current focus of the user.
